(19) United States
(12) Patent Application Publication
(10) Pub. No.: US 2026/0351965 A1
(43) Pub. Date: Nov. 5, 2026

(54) INFORMATION PROCESSING APPARATUS AND POWER SUPPLY CONTROL METHOD

(71) Applicant: Fujitsu Limited, Kawasaki-shi (JP)

(72) Inventor: Kazuya OKAMOTO, Kawasaki (JP)

(73) Assignee: Fujitsu Limited, Kawasaki-shi (JP)

(21) Appl. No.: 19/460,856

(22) Filed: Jan. 27, 2026

(30) Foreign Application Priority Data
Mar. 14, 2025 (JP) 2025-041226

(51) Int. Cl. H02J 1/102; G06F 1/26; G06F 1/30

(52) U.S. Cl. CPC H02J 1/102; G06F 1/263; G06F 1/30

(57) ABSTRACT

An apparatus includes power supply units configured to supply power to a load via an output line. Each of the power supply units includes: output circuitry that, when in a power supplying state, outputs to the output line an output current, and outputs to the output line an output voltage having a characteristic in which a voltage value decreases from a first voltage value in accordance with an increase in the output current, and, when in a stopped state, outputs to the output line the output voltage maintained at a second voltage value lower than the first voltage value; and a controller that performs a control to set the output circuitry to the power supplying state, when the output circuitry is in the stopped state and when a voltage value on the output line becomes equal to or lower than the second voltage value.

### CROSS-REFERENCE TO RELATED APPLICATION

This application is based upon and claims the benefit of priority of the prior Japanese Patent Application No. 2025-041226, filed on Mar. 14, 2025, the entire contents of which are incorporated herein by reference.

### FIELD

The present disclosure relates to an information processing apparatus and a power supply control method.

### BACKGROUND

In an information processing apparatus that causes a plurality of power supply units to operate in parallel according to a load, a technique is known for improving the power efficiency of the plurality of power supply units by increasing or decreasing the number of power supply units that supply power according to a current value flowing to the load or an output power value of the power supply units.

Also known is a technique in which an output voltage of a stopped power supply unit that has stopped supplying power is set to a voltage value slightly lower than an output voltage of a power supply unit that supplies power. In such a technique, for example, when the power supplied to the load (supplied power) becomes insufficient and the voltage value of the output voltage of the power supply unit that supplies power falls below the voltage value of the output voltage of the stopped power supply unit, the stopped power supply unit transitions to a state of supplying power. This enables prompt recovery of power supply to the load.

For example, related arts are disclosed in Japanese Laid-open Patent Publication No. 2011-250653 and Japanese Laid-open Patent Publication No. 2018-085793.

### SUMMARY

According to an aspect of the embodiment, an information processing apparatus including: a plurality of power supply units configured to supply power to a load via an output line, wherein each of the plurality of power supply units includes: output circuitry configured to, when in a power supplying state for supplying the power, output to the output line an output current, and output to the output line an output voltage having a characteristic in which a voltage value decreases from a first voltage value in accordance with an increase in the output current, and, when in a stopped state for stopping the supply of the power, output to the output line the output voltage maintained at a second voltage value that is lower than the first voltage value; and a controller configured to perform a control to set the output circuitry to the power supplying state, when the output circuitry is in the stopped state and when a voltage value on the output line becomes equal to or lower than the second voltage value of the output voltage from the output circuitry.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a hardware configuration of a server according to one embodiment;

FIG. 2 is a block diagram illustrating an example of a hardware configuration of a power supply unit according to one embodiment;

FIG. 3 is a diagram illustrating one example of an output voltage according to an output state of a power supply unit;

FIG. 4 is a diagram illustrating one example of switching of the output states of power supply units in a stabilization control;

FIG. 5 is a diagram illustrating one example of switching of the output states of the power supply units in the stabilization control;

FIG. 6 is a block diagram illustrating an example of a functional configuration of a control unit according to one embodiment;

FIG. 7 is a graph illustrating examples of the relationship between the efficiency and the load current of a power supply unit;

FIG. 8 is a flowchart for explaining an example of an operation of a server according to one embodiment; and

FIG. 9 is a flowchart for explaining an example of an operation of the server according to one embodiment.

### DESCRIPTION OF EMBODIMENTS

In an information processing apparatus, for example, the supplied power may become insufficient depending on the operation of a program executed by the processor, or the supplied power may become insufficient due to a failure of the power supply unit that provides the power. In such cases, the load may change abruptly (e.g., rapidly increase).

In the above-described technique, after the output voltage of the power supply unit that supplies power decreases to the voltage value set for the stopped power supply unit, the supply of power to the load is recovered. However, because the power supply unit that supplies power is already in an overcurrent state at the point when the output voltage decreases (drops) due to an increase in supplied power, an abnormality due to the overcurrent may be detected or a failure may occur, which may cause the power supply unit or the information processing apparatus to stop. As a result, the operation of the information processing apparatus may become unstable.

In a redundant configuration in which power supply units are configured redundantly, the above-described inconvenience may also occur, for example, when the number of power supply units is controlled to perform an operation with good power efficiency (high-efficiency operation).

Hereinafter, an embodiment of the present disclosure will be described with reference to the drawings. However, the embodiment described below is merely exemplary, and it is not intended to exclude various modifications or applications of techniques that are not explicitly described below. For example, the present embodiment can be modified in various manners without departing from the spirit thereof. In the drawings used in the description below, parts denoted by the same reference symbols represent the same or similar parts unless otherwise stated.

### (A) Example of Configuration of Server According to One Embodiment

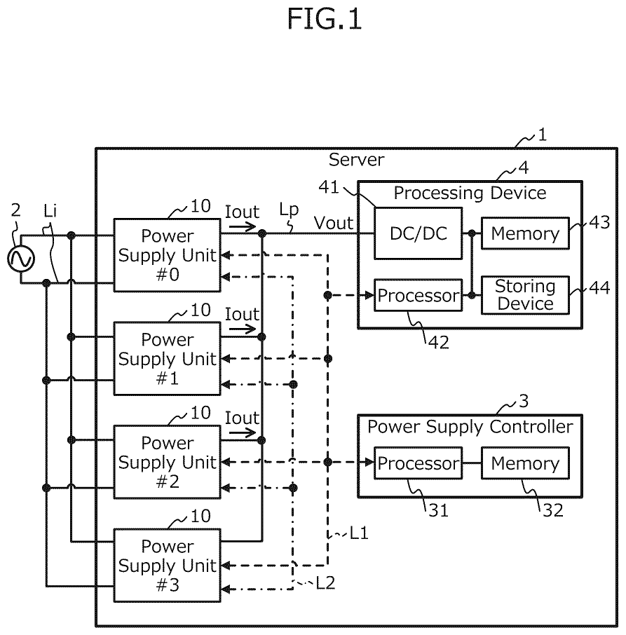

FIG. 1 is a block diagram illustrating an example of the hardware configuration of a server 1 according to one embodiment. The server 1 is one example of a computer, an information processing apparatus, or an information processing system that operates using power supplied from a power source external to the server 1 (external power source). Although FIG. 1 illustrates an example in which the server 1 operates using AC power supplied from an external AC power source 2, the server 1 may instead operate using DC power supplied from an external DC power source. Furthermore, although FIG. 1 illustrates an example in which the external power source is a single power system, the external power source may have two or more power systems (multiple power systems).

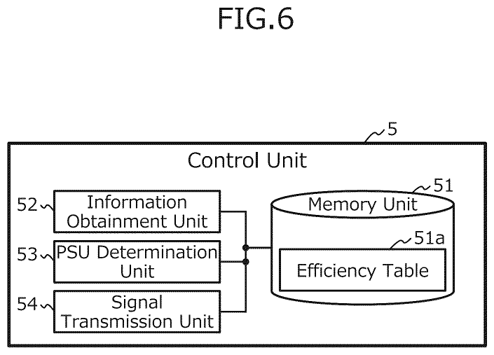

As illustrated in FIG. 1, the server 1 includes a plurality of (four in FIG. 1) power supply units 10 (denoted as power supply units #0 to #3 in FIG. 1), a power supply controller 3, and a processing device 4. One or both of the power supply controller 3 and the processing device 4 is one example of a controller configured to control the plurality of power supply units 10, and may implement functions as a control unit 5 described later (see FIG. 6).

Each power supply unit 10 is connected to a common output line Lp. In the following description, an example is presented in which the server 1 includes four power supply units #0 to #3. However, the number of power supply units 10 provided in the server 1 may be increased or decreased as appropriate depending on the power consumption of the processing device 4, the number of redundant units in a redundant configuration, the number of power systems in the external power source, and the like. In one embodiment, although it is assumed that the plurality of power supply units 10 have equivalent performance, the performances of the power supply units 10 may differ from each other. In the following description, the term “power supply unit” may be referred to as “PSU.”

The power supply controller 3 controls the plurality of PSUs 10. Note that the power supply controller 3 may be provided inside at least one of the power supply units 10. Furthermore, when the processing device 4 is used as the control unit 5, the power supply controller 3 may be omitted.

The power supply controller 3 may include, for example, a processor 31 and a memory 32. The processor 31 is one example of a processing unit that performs various controls and calculations in the power supply controller 3. Examples of the processor 31 include integrated circuits (ICs) such as a CPU, MPU, APU, DSP, ASIC, or FPGA, for example. CPU is an abbreviation for Central Processing Unit, and MPU is an abbreviation for Micro Processing Unit. APU is an abbreviation for Accelerated Processing Unit. DSP is an abbreviation for Digital Signal Processor, ASIC is an abbreviation for Application Specific IC, and FPGA is an abbreviation for Field-Programmable Gate Array.

The memory 32 is one example of a storage unit, and stores various data, programs, and other information used in the power supply controller 3. The memory 32 may store firmware (FW) that embodies functions of the power supply controller 3 described later and control information. Examples of the memory 32 include one or both of volatile memory such as Dynamic Random Access Memory (DRAM), and nonvolatile memory such as Storage Class Memory (SCM) or Read Only Memory (ROM), for example.

The processing device 4 is, for example, a processing functional unit that performs information processing in the server 1, and is one example of a “load” or a load device in the server 1. The processing device 4 is connected to the output line Lp of the plurality of PSUs 10 and operates by the power supplied from the plurality of PSUs 10 via the output line Lp.

Furthermore, when at least one of the power supply controller 3 and the processing device 4 functions as the control unit 5, it may be communicably connected with each of the PSUs #0 to #3 via a signal line L1, and may control each of the PSUs #0 to #3 by transmitting and receiving control signals S1 via the signal line L1.

The processing device 4 may include, for example, a Direct Current (DC)-DC converter 41, a processor 42, a memory 43, and a storing device 44. In the drawings described below, the “DC-DC converter” may be referred to as “DC/DC.”

The DC-DC converter 41 converts the output voltage (DC voltage) Vout applied to the output line Lp into respective operating voltages for the processor 42, the memory 43, and the storing device 44 (for example, step-down conversion). Then, the DC-DC converter 41 outputs the respective converted voltages to the processor 42, the memory 43, and the storing device 44.

The processor 42 is one example of a processor or processing unit that performs various controls and calculations in the processing device 4. Examples of the processor 42 include integrated circuits (ICs) such as a CPU, MPU, APU, DSP, ASIC, or FPGA, for example. The processor 42 may be a combination of two or more of these integrated circuits.

Each of the memory 43 and the storing device 44 stores various data, programs, and other information used in the processing device 4. Examples of the memory 43 include one or both of volatile memory such as DRAM and nonvolatile memory such as SCM, for example. Examples of the storing device 44 include various types of storing devices, including magnetic disk devices such as a Hard Disk Drive (HDD), semiconductor drive devices such as a Solid State Drive (SSD), and nonvolatile memory.

Note that the components provided in the processing device 4 are not limited to the above-described components, and the processing device 4 may also include various components such as an accelerator such as a Graphics Processing Unit (GPU), a wired or wireless communication interface (IF), an Input/Output (IO) device, and a reader for reading information from a recording medium. Furthermore, the processing device 4 is not limited to a computer and may be various devices that can serve as a load that consumes power.

Each PSU 10 supplies DC power to the processing device 4 by outputting the DC power to the output line Lp relying on power supplied from the external power source. In the example of FIG. 1, the PSU 10 converts AC power input from the AC power supply 2 via the input line Li into DC power and supplies the DC power to the processing device 4 via the output line Lp. Furthermore, the plurality of PSUs 10 are communicatively connected to each other via a signal line L2.

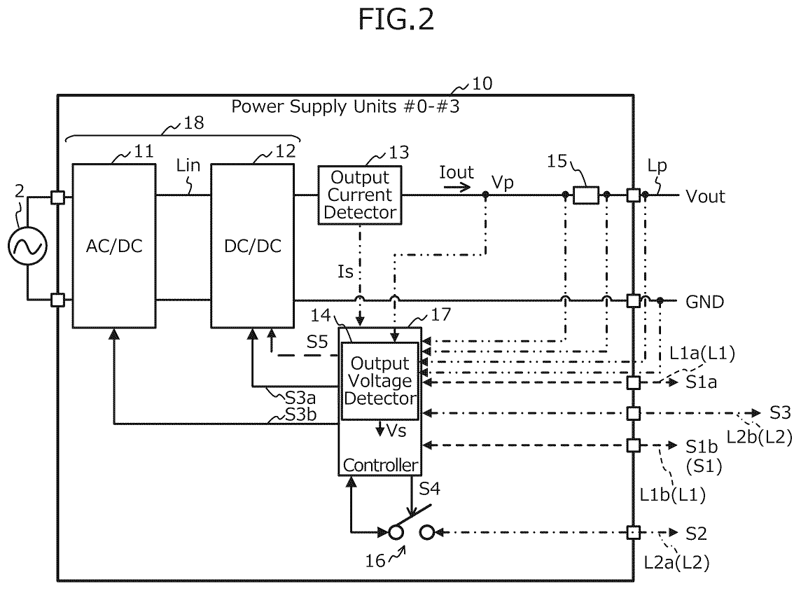

Here, the “power supplying state” refers to a state in which the DC-DC converter 12 (see FIG. 2) supplies power to the processing device 4, and in the following description, this state may also be referred to as the “operating state” or simply “operating.” On the other hand, a state in which the DC-DC converter 12 stops the supply of power to the processing device 4 is referred to as a “stopped state.” A PSU 10 in the stopped state can be regarded as a standby system prepared for a shortage of supply power. Accordingly, in the following description, the stopped state may also be referred to as the “standby state” or simply “standby.” Each of the operating state and the standby state is one mode of the “output state” of the PSU 10.

Each PSU 10 can individually perform switching or maintenance of the output state thereof based on a determination made by the PSU 10 or based on instructions from the power supply controller 3. In the following description, a PSU 10 in the standby state may be referred to as a “standby PSU 10,” and a PSU 10 in the operating state may be referred to as an “operating PSU 10.”

### (A-1) Example of Configuration of Power Supply Unit

FIG. 2 is a block diagram illustrating an example of the hardware configuration of a power supply unit 10 according to one embodiment. Each of the PSUs 10 (#0 to #3) according to one embodiment includes, for example, an Alternate Current (AC)-DC converter 11, a DC-DC converter 12, an output current detector 13, an output voltage detector 14, a reverse current prevention unit 15, a switch 16, and a controller 17. In the drawings described hereinafter, the “AC-DC converter” may be denoted as “AC/DC.” In the following, at least one of the AC-DC converter 11 and the DC-DC converter 12 may be collectively referred to as the power conversion circuit 18.

The AC-DC converter 11 converts AC power supplied from the external AC power source 2 into DC power, and outputs the DC power to the DC-DC converter 12 via an input line Lin. The AC-DC converter 11 may be connected to the controller 17 via a signal line, and may receive a voltage adjustment signal S3 from the controller 17 via the signal line. When the external power source is a DC power source, the AC-DC converter 11 may be omitted, and in such a case, the power conversion circuit 18 may include one or more DC-DC converters 12.

The DC-DC converter 12 is one example of an output unit that outputs power to the processing device 4. The DC-DC converter 12 steps down an input voltage Vin, which is the DC voltage applied to the input line Lin, and applies (outputs) an output voltage Vp, which is the stepped-down DC voltage, to the output line Lp. The DC-DC converter 12 also outputs an output current Iout corresponding to the load, to the output line Lp. The output current Iout is one example of the load current. The DC-DC converter 12 may be connected to the controller 17 via a signal line, and may receive the voltage adjustment signal S3 from the controller 17 via the signal line.

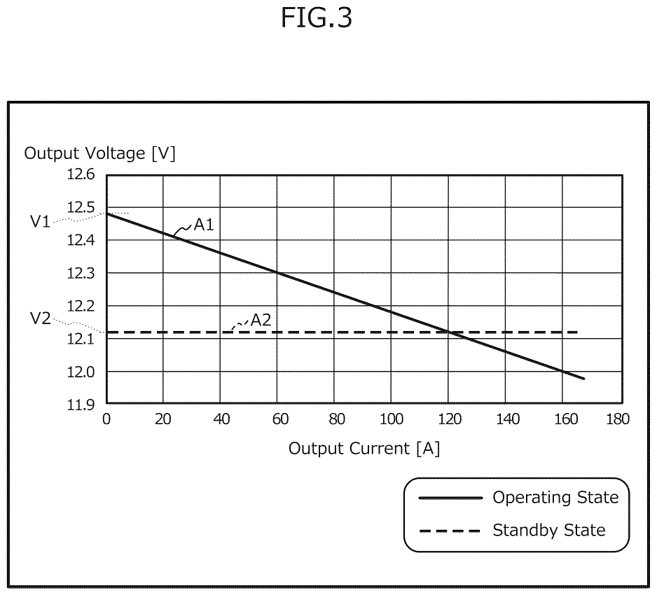

FIG. 3 is a diagram for explaining one example of the output voltage Vp according to the output state of the PSU 10. FIG. 3 illustrates a graph of the output voltage Vp according to the output current Iout for each output state, where the horizontal axis represents the output current Iout and the vertical axis represents the output voltage Vp. In the DC-DC converter 12, the output voltage Vp varies depending on the output state.

When in the operating state, as indicated by the reference symbol A1, the DC-DC converter 12 outputs a voltage that gradually decreases in voltage value in accordance with an increase in the output current Iout, as the output voltage Vp. This characteristic may be referred to as a droop characteristic. The droop characteristic according to one embodiment is assumed to be set, for example, as follows:
The output current Iout and the output voltage Vp follow a negative linear function (linear) within a given range. The given range may include at least a range in which the output current Iout is zero (0) or more and is equal to or less than the maximum current value that can be output by the PSU 10.
The output voltage Vp (the intercept with the vertical axis) when the output current Iout is zero (when there is no load), in other words, the initial value, is a voltage value V1. The voltage value V1 is one example of a first voltage value.
The amount of decrease (slope) of the output voltage Vp in accordance with the output current Iout is set according to the power conversion efficiency of the PSU 10.

When power is supplied to the processing device 4 by any one of PSU #0 to #3, the voltage value of the output line Lp (output voltage Vout) is the output voltage Vp of the operating PSU 10, which is a voltage value corresponding to the current value of the output current Iout according to the droop characteristic. Such output of the output voltage Vp according to the droop characteristic may be achieved by the droop function of a droop circuit (not illustrated) provided in the DC-DC converter 12, for example.

Here, the current value of the output current Iout output from the operating PSU 10 is determined according to the power consumption of the processing device 4, and is adjusted by the current balancing function so that the magnitude of the output current Iout matches among the other operating PSUs 10. Accordingly, when a plurality of operating PSUs 10 in parallel operation all have equivalent performance (specifications), and both the droop function and the current balancing function of each operating PSU 10 are enabled, both the output voltage Vp and the output current Iout (in other words, output power) become equivalent among the plurality of operating PSUs 10.

The current balancing function is a function for matching the current values of the output currents Iout output to the output line Lp among the plurality of operating PSUs 10. The current balancing function may be achieved, for example, by controlling the DC-DC converter 12 by a current balance circuit (not illustrated) provided in the controller 17. For example, by transmitting and receiving a current balance signal S2 via a signal line L2a between a plurality of controllers 17 in the operating state, the current balance circuit controls the plurality of DC-DC converters 12 so that the output currents Iout match. The current balance signal S2 may be a signal indicating a value that has a positive correlation with the output current Iout of the operating PSU 10, for example.

The current balancing function includes a voltage adjustment function as a related function. The voltage adjustment function is a function for increasing or decreasing the output voltage value of the output voltage Vp so that the equal output currents Iout are output from the plurality of DC-DC converters 12 in the operating state. Note that the voltage adjustment function may also be embodied by a circuit provided in the power conversion circuit 18 (for example, a current balance circuit and a circuit provided in the AC-DC converter 11), and may be embodied by the cooperation of these circuits. For example, by transmitting and receiving voltage adjustment signals S3 (S3a and S3b) via the controller 17 and a signal line L2b among the plurality of operating PSUs 10, the power conversion circuit 18 may control the output voltages Vp such that the output currents Iout match among the plurality of operating PSUs 10. The voltage adjustment signals S3 (S3a and S3b) are signals used for controlling the voltage adjustment function, and may be signals indicating values that have a negative correlation with the output current Iout of the operating PSUs 10, for example. The voltage adjustment signal S3a is a signal transmitted and received by the DC-DC converter 12, and the voltage adjustment signal S3b is a signal transmitted and received by the AC-DC converter 11.

The droop function cooperates with the current balancing function and the voltage adjustment function described above to control the increase and decrease of the voltage value of the output voltage Vp in accordance with the current value of the output current Iout so that the droop characteristic illustrated in FIG. 3 functions.

When in the standby state, the DC-DC converter 12 maintains the output of the output voltage Vp as indicated by the reference symbol A2, but the voltage value thereof is a voltage value V2 that is slightly (about 0.36 V in the example of FIG. 3) smaller than the voltage value V1 in the operating state (initial value of the droop characteristic). The voltage value V2 is one example of the second voltage value and may be about 80% to 98% of the voltage value V1, for example. As long as the voltage value V2 of the output voltage Vp of the DC-DC converter 12 in the standby state is smaller than the voltage value of the output voltage Vout (see FIG. 1) on the output line Lp, reverse current from the operating PSUs 10 is prevented by the reverse current prevention unit 15 described later. In other words, the current value of the output current Iout of the DC-DC converter 12 in the standby state becomes zero, similarly to when the PSU 10 is completely stopped (for example, when both the output voltage Vp and the output current Iout are set to zero).

In the standby state, both the droop function and the current balancing function described above are disabled in order for the DC-DC converter 12 to maintain the output voltage Vp at the voltage value V2. By disabling these functions, the output voltage Vp is maintained at the voltage value V2 without the voltage value changing in response to increases or decreases in the load current. In addition, the output current Iout is prevented from being affected by the load current of other operating PSUs 10 and is maintained at zero. Thus, by disabling these functions, the output voltage Vp of the DC-DC converter 12 can be stabilized at the voltage value V2 and the output current Iout can be made zero, thereby facilitating transition to the standby state.

Enabling and disabling of the droop function, the current balancing function, and the voltage adjustment function may be controlled by the controller 17 either in hardware or in software. Enabling or disabling of these functions may be performed by various methods, including enabling or disabling of the circuits implementing the functions, switching to a path or bypass path through the circuits, and changing signals or setting values. In the following description, enabling these functions to set the PSUs 10 (the DC-DC converter 12) to the operating state may be collectively referred to as “enabling control.” In contrast, disabling these functions to set the PSUs 10 (the DC-DC converter 12) to the standby state may be collectively referred to as “disabling control.”

Returning to the description of FIG. 2, the output current detector 13 is an element or a circuit that measures the magnitude of a current. Examples of the output current detector 13 include various sensors, resistors (for example, those connected in series on a line so that the voltage across both ends is measured by the controller 17 to calculate the current value), and current detection elements. The output current detector 13 outputs to the controller 17 a current detection signal Is indicating the magnitude of the output current Iout output from the DC-DC converter 12.

The output voltage detector 14 is an element or circuit that measures the magnitude of voltage and may be, for example, various sensors. The output voltage detector 14 outputs a voltage detection signal Vs indicating the magnitude of the output voltage Vp on the output line Lp. In the example of FIG. 2, the output voltage detector 14 may be provided inside the controller 17. The output voltage Vp between the DC-DC converter 12 and the reverse current prevention unit 15, the voltage on the output line Lp on the processing device 4 side relative to the reverse current prevention unit 15 (for example, the output voltage Vout), and the voltage on the GND line may each be input to the output voltage detector 14 via the signal lines, and signals indicating the magnitudes of various voltages may be output using these.

The reverse current prevention unit 15 prevents reverse current from the output line Lp on the processing device 4 side into the DC-DC converter 12. The reverse current prevention unit 15 may include a semiconductor element such as a Field Effect Transistor (FET), for example, and may be interposed on the output line Lp inside the PSU 10. The reverse current prevention unit 15 turns off (disconnects) the output line Lp inside the PSU 10 when the output voltage Vp of the DC-DC converter 12 is lower than the voltage (output voltage Vout) on the output line Lp on the processing device 4 side, and turns on (conducts) the output line Lp inside the PSU 10 when the output voltage Vp is equal to or higher than the output voltage Vout.

When the output voltage Vp is smaller than the output voltage Vout, a voltage difference of (output voltage Vout−output voltage Vp) is generated between both ends of the reverse current prevention unit 15 (on the DC-DC converter 12 side and on the processing device 4 side). In one embodiment, the voltage values at both ends of the reverse current prevention unit 15 are input to the controller 17 via signal lines as signals for measuring this voltage difference. Alternatively, instead of the voltage value on the DC-DC converter 12 side of the reverse current prevention unit 15, the voltage value indicated by the output voltage detector 14 may be used. Note that among the various signal lines illustrated in FIG. 2 which are input to the controller 17, those that are duplicated with each other may be omitted as appropriate.

The switch 16 is provided on the signal line L2a to switch the signal line L2a between an ON (connecting) state and an OFF (disconnecting) state according to the state of a switch control signal S4 input from the controller 17 via a control line to the controller 17. In the ON state, transmission and reception of the current balance signal S2 is allowed in the controller 17, thereby enabling the current balancing function. On the other hand, in the OFF state, transmission and reception of the current balance signal S2 is not allowed in the controller 17, thereby disabling the current balancing function. Note that the switch 16 may be provided inside the controller 17.

The controller 17 performs various controls in the PSU 10. Examples of the controller 17 include control circuits such as integrated circuits, for example. Although FIG. 2 illustrates an example in which the PSU 10 includes one controller 17, the PSU 10 may include one or more controllers 17 provided corresponding to each component of the power conversion circuit 18 (the AC-DC converter 11 and the DC-DC converter 12).

The controller 17 is connected to signal lines L1a and L1b and performs communications with the control unit 5 (the power supply controller 3 or the processing device 4) via the signal lines L1a and L1b. The signal lines L1a and L1b are examples of the signal line L1 illustrated in FIG. 1. The signal line L1 (either or both of L1a and L1b) may be a communication bus compliant with a communication standard such as Power Management Bus (PMBus), for example. Each of the signal lines L1a and L1b may be a signal line having two or more wires.

Furthermore, the controller 17 is connected to a signal line L2a and performs transmission and reception of the current balance signal S2 with another PSU 10 via the signal line L2a. Additionally, the controller 17 is connected to a signal line L2b and performs transmission and reception of the voltage adjustment signal S3 with the controllers 17 of other PSUs 10 via the signal line L2b. The signal lines L2a and L2b are examples of the signal line L2 illustrated in FIG. 1.

The controls performed by the controller 17 may include, for example, a stabilization control for improving the stability of the operation of the server 1, and the efficiency control for improving the power efficiency of the plurality of PSUs 10. In the stabilization control, the output state of the PSU 10 is controlled so as to be switched from the standby state to the operating state. In the efficiency control, the output state of the PSU 10 is controlled so as to be switched from the standby state to the operating state, or from the operating state to the standby state. Examples of these controls will be described below.

### (A-1-1) Stabilization Control

The controller 17 performs the stabilization control when the local PSU 10 is in the standby state. The controller 17 performs a control to set the DC-DC converter 12 to the operating state when the output voltage Vout on the output line Lp becomes equal to or lower than the voltage value V2 of the output voltage Vp from the DC-DC converter 12. For example, when the controller 17 detects a rapid increase in the load based on detected signals, the controller 17 switches the output state of the local PSU 10, from the standby state to the operating state.

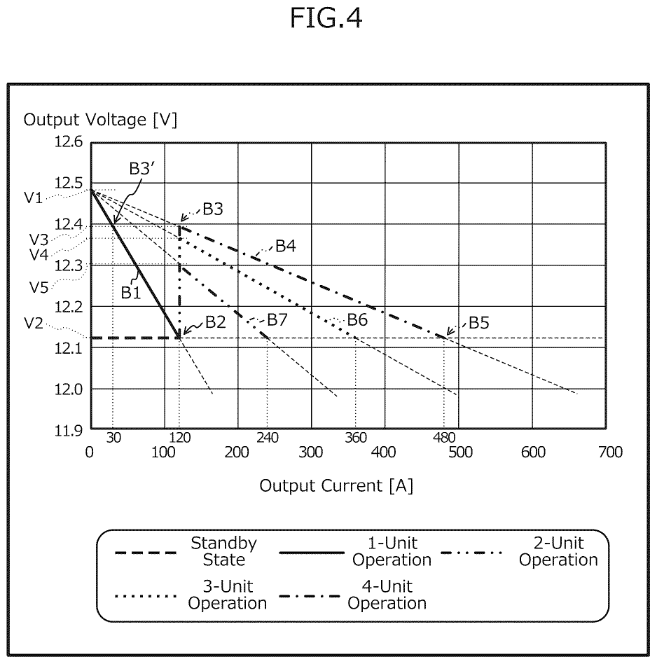

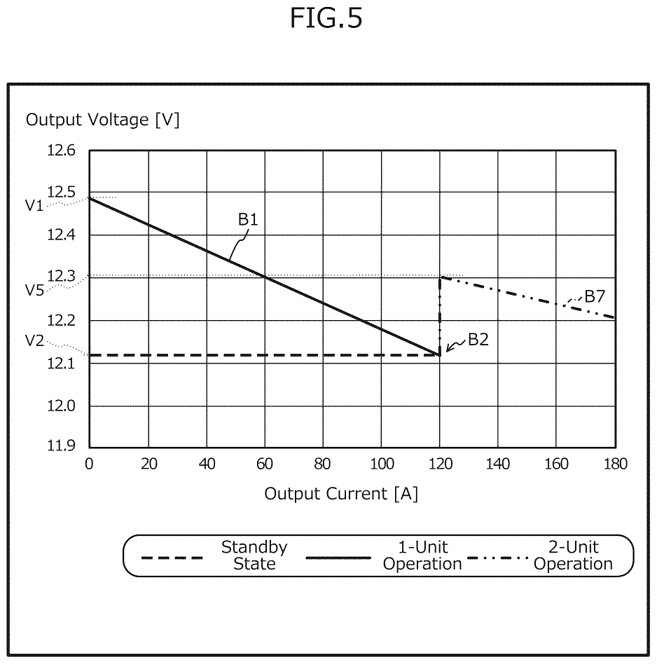

FIGS. 4 and 5 are diagrams illustrating examples of switching of the output states of the PSUs 10 in the stabilization control. In FIGS. 4 and 5, the vertical axis represents the output voltage Vp of the PSU 10, and the horizontal axis represents the sum of the output currents Iout of the plurality of PSUs 10 (load current input to the load). In FIG. 4, a case is assumed in which only one of the four PSUs 10 (for example, PSU #0) is in the operating state and the remaining three PSUs 10 (for example, PSUs #1 to #3) are in the standby state when the output current Iout is near 0 A.

In FIG. 4, the thick dashed line indicates the output voltage Vp of each standby PSU 10. The thick solid line indicates the output voltage Vp of the operating PSU #0 when only one of the four PSUs is in the operating state. The thick one-dot chain line indicates the output voltage Vp of each of the operating PSUs #0 to #3 when all four are in the operating state. In the example of FIG. 4, the voltage value V1 is 12.484 V, the voltage value V2 is 12.120 V, the voltage value V3 is 12.393 V, the voltage value V4 is 12.362 V, and the voltage value V5 is 12.302 V.

When one PSU #0 is in the operating state, the output voltage Vp gradually decreases from the voltage value V1 in accordance with an increase in the output current Iout (see the reference symbol B1) according to the droop characteristic, and becomes equal to the voltage value V2 when the output current Iout reaches 120 A (see the reference symbol B2).

In three PSUs #1 to #3 in the standby state, each controller 17 performs the following process. The controller 17 obtains, for example, the voltage values at both ends of the reverse current prevention unit 15. The voltage value on the processing device 4 side of the reverse current prevention unit 15 is the output voltage Vp of the operating PSU #0 (in other words, the output voltage Vout applied to the processing device 4), and the voltage value on the DC-DC converter 12 side of the reverse current prevention unit 15 is the voltage value V2 of the local PSU 10 (standby PSU 10).

Each controller 17 determines (monitors) whether or not the voltage difference between the two voltage values is zero (i.e., whether the two voltage values are equal), and if the voltage difference is not zero (for example, when (output voltage Vout−output voltage Vp) is greater than 0), the controller 17 maintains the standby state. On the other hand, if the voltage difference becomes zero or less, the controller 17 performs the enabling control to switch the local PSU 10 (DC-DC converter 12) from the standby state to the operating state. Whether or not the voltage difference is zero or less is one example of an operation start condition that serves as a trigger to perform the enabling control, and the fact that the voltage difference has become zero or less may mean that the operation start condition has been satisfied.

The controller 17 enables each of the droop function, the current balancing function, and the voltage adjustment function, which are in a state under the disabling control, by performing the enabling control.

Enabling or disabling of the droop function may be performed by, for example, transmitting a control signal S5 via a control line between the controller 17 and the DC-DC converter 12. The controller 17 may enable or disable the droop function by transmitting different values indicating enabling and disabling as the control signal S5. In the enabling control, the control signal S5 having a value indicating enabling is transmitted to enable the droop function.

Enabling or disabling of the current balancing function may be performed by, for example, transmitting a switch control signal S4 from the controller 17 to the switch 16. The controller 17 may allow transmission and reception of the current balance signal S2 in the controller 17, for example, by setting the value of the switch control signal S4 to a value indicating the ON state of the switch 16. As a result, the current balancing function is enabled.

Enabling or disabling of the voltage adjustment function may be performed, for example, by adjusting each component of the power conversion circuit 18 by the controller 17. The controller 17 may switch the voltage adjustment function between an enabled state and a disabled state based on the presence or absence of an offset relative to a reference voltage, thereby enabling the voltage adjustment function.

Upon completion of the enabling control, in each of PSUs #1 to #3, the DC-DC converter 12 increases the output voltage Vp from the voltage value V2 in the standby state to the voltage value V3 corresponding to the load current according to the droop characteristic. Then, each DC-DC converter 12 in PSUs #1 to #3 outputs the output voltage Vp with a voltage value V3 to the output line Lp (see the reference symbol B3 in FIG. 4). In this manner, when the operation start condition is satisfied and the enabling control is completed, all standby PSUs 10 that have a droop function and are capable of operating (for example, not faulty) transition to the operating state.

By increasing the number of operating PSUs 10 from one to four, the load on each PSU 10 is reduced. For example, the output current Iout per unit can be reduced from 120 A to 30 A (120 A/4 units). Since the output current Iout per unit is reduced, the output voltage Vp per operating PSU 10 can be increased from the voltage value V2 to the voltage value V3 according to the droop characteristic. Note that the voltage value V3 indicated by the reference symbol B3 corresponds to the output voltage Vp per PSU 10 (see the reference symbol B3′) when each of the four PSUs 10 in the operating state outputs an output current Iout of 30 A (120 A/4 units).

Even in a case where four PSUs 10 operate, in each PSU 10, the output voltage Vp decreases according to the droop characteristic as the output current Iout (load current) increases (see the reference symbol B4). However, the slope of the droop characteristic in the case where four PSUs operate is about one-quarter of the slope of the droop characteristic in the case where one PSU operates (see the reference symbol B1), because the increase in the load current is shared among the number of operating PSUs 10. In the example of FIG. 4, the output voltage Vp of each of the four operating PSUs 10 becomes equal to the voltage value V2 when the load current reaches 480 A (120 A per one PSU 10) (see the reference symbol B5).

Note that the process of the stabilization control in cases where the number of PSUs 10 having a droop function and capable of operating is fewer than four or five or more is the same as described above, although the slope of the droop characteristic differs depending on the number of units operating (becoming smaller as the number increases). Below, a case where the number of PSUs 10 having the droop function and capable of operating is fewer than four will be described as an example.

In FIG. 4, the thick dotted line indicates the output voltage Vp of each PSU #0 to #2 when only three of the four units (for example, PSUs #0 to #2) are in the operating state. When the output voltage Vp of one operating unit drops to the voltage value V2 (see the reference symbol B2), two units in the standby state transition to the operating state, and each of the three PSUs 10 outputs the output voltage Vp with a voltage value V4 (see the reference symbol B6).

In FIGS. 4 and 5, the thick two-dot chain line indicates the output voltage Vp of each PSU #0 and #1 when only two of the four units (for example, PSUs #0 and #1) are in the operating state. When the output voltage Vp of one operating unit drops to the voltage value V2 (see the reference symbol B2), one unit in the standby state transitions to the operating state, and each of the two PSUs 10 outputs the output voltage Vp with a voltage value V5 (see the reference symbol B7).

If the droop function is not used, for example, when a standby PSU is completely stopped, the output voltage would have to be raised from 0 V to transition to the operating state. In contrast, according to the server 1 of one embodiment, in the operating PSU 10, the output voltage Vp gradually decreases as the load current increases (see the reference symbol B1 in FIG. 5), and at the timing when the number of operating units is switched (see the reference symbol B2), the voltage value becomes approximately the same as the voltage value V2 of the standby state. Accordingly, the voltage difference of the output voltage Vp among the PSUs 10 in the operating state and the standby state when the number of operating units is increased can be eliminated (or made extremely small), and therefore, it is possible to control the switching of the number of PSUs 10 without delay (or with a very small delay).

For example, in a case where supply power becomes insufficient due to a rapid increase in load or a failure of an operating PSU 10, and the load changes rapidly (for example, the load rapidly increases), the load current may increase suddenly. Even in such a case, the transition time from the standby state to the operating state can be shortened, enabling prompt recovery of power supply to the load and stabilizing the operation of the server 1. For example, a redundant configuration may be maintained more flexibly compared to the conventional methods. Particularly, when the control of the enabling control is embodied in hardware, the transition time from the standby state to the operating state can be further shortened, thereby enabling further improvement in the operational stability of the server 1.

Also, in the conventional methods, when the load increases rapidly, the voltage difference between the output voltage of a PSU supplying power and the output voltage of a PSU not supplying power is instantaneously reduced. In this case, the system experiences an unstable state in which fluctuations in output voltage and output current occur, and a period may arise in which the load on the PSUs increases (an overcurrent occurs). Accordingly, the PSU or the server would stop due to detection of an abnormality caused by the overcurrent or failure, and the operation of the server would become unstable.

In contrast, according to the server 1 of one embodiment, each PSU 10 is controlled so that the output voltage Vp has the droop characteristic described above when in the operating state or the stabilization control described above is executed while the output voltage Vp is maintained at the voltage value V2 when in the standby state. As a result, the PSU 10 in the standby state can stop the output of the output current Iout and, when it transitions to the operating state, the PSU 10 can start outputting the output voltage Vp having a voltage value corresponding to the load earlier than raising from 0 V, which improves the stability of the operation of the server 1.

### (A-1-2) Efficiency Control

Each controller 17 of all the PSU 10 performs an efficiency control in response to the control signal S1 from the control unit 5.

The controller 17, for example, supplies (outputs) signals S1a and S1b to the control unit 5 via the signal lines L1a and L1b, as information used for control by the control unit 5. The signal S1a is a signal indicating the load condition of the PSU 10 and may include, for example, a signal indicating the value of the output current Iout (as one example, the current detection signal Is). As the signal indicating the load state, for example, a load factor obtained by dividing the output power value of the PSU 10 (output voltage Vp×output current Iout) by the rated power value of the PSU 10 may be used.

In addition to the signal indicating the load condition, the signals S1a and S1b may include, for example, at least one type of the following information:
A signal indicating the value of the input voltage supplied to the power conversion circuit 18. The input voltage may be, for example, the voltage applied to the input line Lin.
In addition to the signal indicating the load state, a signal indicating the internal temperature of the power conversion circuit 18 (for example, the DC-DC converter 12). The internal temperature of the DC-DC converter 12 may be, for example, a component temperature of a device that is mounted in the DC-DC converter 12 and generates heat due to current.
A signal indicating the value of the input current or input power supplied to the power conversion circuit 18.

In the following description, it is assumed that the signals S1a and S1b include the various signals described above. The signals S1a and S1b may further include signals indicating various information requested by the control unit 5. Note that the power conversion circuit 18 may be provided with sensors for detecting each of such various types of information, and the values detected by the sensors may be input to the controller 17.

Based on the signals S1a and S1b obtained from the plurality of controllers 17, the control unit 5 determines the output state to be set for each PSU 10 from the viewpoint of efficiency. The control unit 5 then transmits operation control signals S1a and S1b that control the output state to each PSU 10 (controller 17) via the signal lines L1a and L1b. The operation control signals S1a and S1b may indicate different values depending on whether the instruction is to set the PSU to the operating state (operation instruction) or to the standby state (standby instruction), for example. The operation control signals S1a and S1b may also include various instructions, such as instructions instructing the controller 17 to obtain information. The signal S1a and the operation control signal S1b are examples of the control signal S1.

The controller 17 sets the output state of the local PSU 10 to the operating state or the standby state by performing the enabling control or the disabling control described above, based on the value indicated by the received operation control signals S1a and S1b, for example. In response to receiving the operation control signals S1a and S1b indicating an operation instruction, the controller 17 may perform the enabling control described above.

Furthermore, in response to receiving the operation control signals S1a and S1b indicating a standby instruction, the controller 17 may perform the disabling control. In the disabling control, for example, a control signal S5 having a value indicating disablement is transmitted from the controller 17 to the droop circuit, and the droop function is disabled. Also, for example, a switch control signal S4 having a value indicating the OFF state of the switch 16 is transmitted from the controller 17, and transmission and reception of the current balance signal S2 in the controller 17 is suppressed. As a result, the current balancing function is disabled. Furthermore, for example, the voltage adjustment function is disabled by causing the controller 17 to change the presence or absence of an offset relative to the reference voltage.

Thus, in the efficiency control, the output state of each PSU 10 is controlled from the viewpoint of efficiency. Accordingly, for example, once all PSUs 10 transition to the operating state by the stabilization control, it is possible to control the number of operating PSUs by the efficiency control such that the number of operating PSUs 10 is optimized to achieve improved efficiency (for example, maximized efficiency).

### (A-2) Configuration Example of Control Unit

FIG. 6 is a block diagram illustrating an example of the functional configuration of the control unit 5 according to one embodiment. As illustrated in FIG. 6, the control unit 5 may include a memory unit 51, an information obtainment unit 52, a PSU determination unit 53, and a signal transmission unit 54.

The functions of the information obtainment unit 52, the PSU determination unit 53, and the signal transmission unit 54 may be embodied by the processor 42 illustrated in FIG. 1 that executes a program stored in the memory 43. In this case, the memory unit 51 may be embodied using at least a part of the storage areas of the memory 43 and the storing device 44 illustrated in FIG. 1.

Alternatively, the functions of the information obtainment unit 52, the PSU determination unit 53, and the signal transmission unit 54 may be embodied by the processor 31 illustrated in FIG. 1 that executes a program stored in the memory 32, or that operates in accordance with circuit logic set in the processor 31. In this case, the memory unit 51 may be embodied using at least a part of the storage areas of the memory 32 illustrated in FIG. 1.

The information obtainment unit 52 obtains various information from each of the plurality of PSUs 10. The information obtainment unit 52 may obtain information at given cycles (for example, every several milliseconds to several seconds), for example. The information obtainment unit 52 may obtain the load (for example, the current value of the output current Iout) of each PSU 10 based on the signals S1a and S1b received from each PSU 10 via the signal lines L1a and L1b. Note that the information obtainment unit 52 may further obtain at least one type of information among the input voltage, temperature, and input current or input power of each PSU 10, based on the signals S1a and S1b.

The PSU determination unit 53 determines the number N (N is an integer of 1 or greater) of PSUs 10 to be set to the operating state, based on the information obtained from the plurality of PSUs 10. Note that the PSU determination unit 53 may perform processing at given cycles. First, the relationship between the load and efficiency will be described.

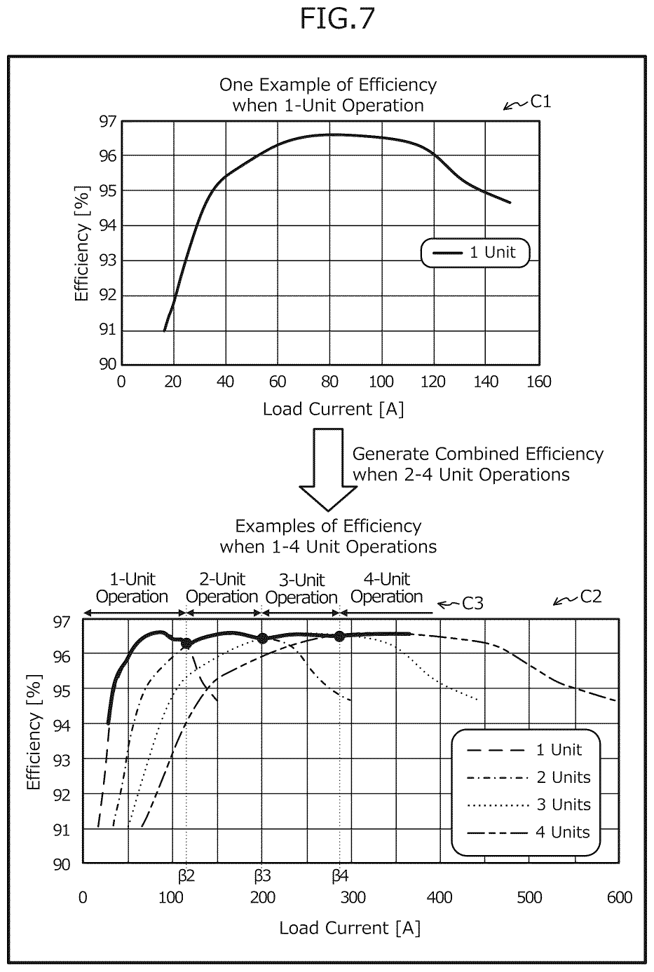

FIG. 7 is a graph illustrating examples of the relationship between the efficiency and the load current of the PSU 10. The reference symbol C1 indicates a graph in the case of a 1-unit operation (single-unit operation), and the reference symbol C2 indicates graphs in the cases of a 2-unit operation (dual-unit operation), 3-unit operation (triple-unit operation), and 4-unit operation (quadruple-unit operation). The load current is one example of the load. Examples of the efficiency include the power conversion efficiency (power efficiency) of the DC-DC converter 12 (or the AC-DC converter 11 and the DC-DC converter 12), for example.

As indicated by the reference symbol C1 in FIG. 7, the efficiency of the PSU 10 changes depending on the load current and has a peak at a certain load current. Hereinafter, a curve (graph) indicating such a relationship between the efficiency and the load current as illustrated in FIG. 7 may be referred to as an “efficiency curve.”

The reference symbol C2 indicates, with a bold solid line (bold ridge line), a combined efficiency curve generated by combining each efficiency curve in the cases of the 2-unit operation, 3-unit operation, and 4-unit operation in addition to the efficiency curve of the 1-unit operation. In the combined efficiency curve, the load current value at which the efficiency curve of the 1-unit operation and the efficiency curve of the 2-unit operation intersect is defined as β2. Similarly, in the combined efficiency curve, the load current value at which the efficiency curve for the 2-unit operation and the efficiency curve for the 3-unit operation intersect is defined as β3, and the load current value at which the efficiency curve for the 3-unit operation and the efficiency curve for the 4-unit operation intersect is defined as β4. The current values at these intersection are change points at which the number N of operating PSUs that provides a higher efficiency changes in accordance with changes in the load current value, and are examples of one or more thresholds (switching points) for switching the number of PSUs 10 to be set to the operating state. As indicated by the reference symbol C2, as the number of PSUs 10 in operation increases, the load current range in which a higher efficiency is obtained shifts toward the higher load side.

The PSU determination unit 53 determines the number N of operating units in accordance with the load current (A) that is the sum of the output current Iout obtained from each PSU 10, for example, at given cycles, as described below (see the reference symbol C3).
1-unit operation (N=1): 0≤load current<β2
2-unit operation (N=2): β2≤load current <β3
3-unit operation (N=3): β3≤load current <β4
4-unit operation (N=4): β4≤load current

As indicated by the reference symbol C3, the efficiency can be improved (for example, optimized) when the load current is less than β4 by adaptively controlling the number N of operating units in accordance with the load current by the PSU determination unit 53.

The information for each point on the graph indicated by the reference symbol C1 or C2 in FIG. 7, in other words, the relationship among the efficiency, the load current, and the input voltage, may be measured and calculated in advance, and stored in the efficiency table 51a, for example. Furthermore, the PSU determination unit 53 may calculate the efficiency of each PSU 10 at timings such as given cycles or cycles longer than the given cycles, and may update the efficiency table 51a, for example. Note that the efficiency table 51a may be generated and updated for each PSU 10. For example, the efficiency table 51a may store the initial value of the efficiency value and the present value of the efficiency value for a load factor (current value).

Alternatively, the efficiency table 51a may store at least the relationship between the values of the load current corresponding to the timing for switching the number N of operating units, for example, the values of β2, β3, and β4, and the number N of operating units corresponding to each load current range (refer to the relationship described with reference to the reference symbol C3). Since the values of β (β2, β3, β4, . . . ) vary depending on the input voltage, the relationship with the input voltage may also be stored.

As one example, the efficiency table 51a may store the number N of operating units, the load current (or the output current Iout per PSU 10), the efficiency (initial value and current value), and the input voltage in association with each other. The efficiency may be calculated, for example, as (output power/input power×100). In the case of direct current, the input power is calculated as input voltage×input current, and the output power is calculated as output voltage Vp×output current Iout. Note that the efficiency value at present may slightly decrease (for example, by a reduction amount of 0.1% or less relative to the initial value) depending on the degradation of components of the PSU 10.

The PSU determination unit 53 determines the PSUs 10 to be set to the operating state (and the PSUs 10 to be set to the standby state) such that the number of PSUs 10 in the operating state at present becomes equal to the determined number N of operating units. A method for determining PSUs 10 to be set to the operating state (hereinafter, they may be referred to as “operating PSUs 10”) will be described later.

The signal transmission unit 54 transmits the operation control signals S1a and S1b indicating the operating state to each of the determined PSUs 10. The signal transmission unit 54 also transmits the operation control signals S1a and S1b indicating the standby state to each of the PSUs 10 determined to be set to the standby state (i.e., determined not to be set to the operating state).

As described above, the control unit 5 controls the output state of each PSU 10 from the viewpoint of efficiency, based on the information obtained from the plurality of PSUs 10. Accordingly, one or more PSUs 10 can be operated in an optimal number along the region where a high efficiency can be achieved (see the bold solid line of the reference symbol C2 and the reference symbol C3 in FIG. 7), and the server 1 can be operated with a high efficiency.

Note that the current value β2 indicated by the reference symbol C2 in FIG. 7 may correspond to the load current value at which the output voltage Vp reaches the voltage value V2 in the droop characteristic of the PSU 10. In other words, the droop circuit of the DC-DC converter 12 is set so that when the output current Iout of the operating PSU 10 reaches the threshold β2, which is a current value at which the number of operating PSUs achieving a higher power conversion efficiency is switched from one to two, the output voltage Vp output from the operating PSU 10 becomes equal to the voltage value V2.

Hence, for example, the control unit 5 may notify the value of β2 or the setting value of the slope of the droop characteristic to the controller 17 in each PSU 10. The controller 17 may calculate the setting value of the slope based on the value of β2 or may obtain the setting value from the control unit 5, and set the setting value in the droop circuit. As a result, the timing (load current value) at which the operation start condition is satisfied matches a timing suitable for switching to the 2-unit (multiple-unit) operation from the viewpoint of efficiency. Accordingly, it is possible to improve the stability of the operation of the server 1 while improving the power conversion efficiency, thereby improving the overall efficiency in the server 1.

Furthermore, since both the stabilization control and the efficiency control described above can be implemented using the configurations and functions provided in the server 1 (PSU 10, power supply controller 3, and processing device 4), it is possible to avoid the addition of special circuits or facilities and thereby reduce any increase in installation cost.

### (A-2-1) Example of Method for Determining Operating Units

Here, an example of a method for determining the operating PSUs 10 by the PSU determination unit 53 will be described.

Even when the PSUs 10 have identical performance and identical specifications, the efficiency of each PSU 10 tends to decrease (reduce) as its operating time increases. In other words, the shorter the operating time of a PSU 10, the higher its efficiency is.

Therefore, the PSU determination unit 53 may, for example, select up to the number N of operating PSUs 10 from among the plurality of PSUs 10, in descending order of efficiency, for example. As a result, a PSU 10 with better efficiency than others can be preferentially selected as an operating PSU 10 and set to the operating state.

Note that the PSU determination unit 53 may record, in the memory unit 51, identification information of a PSU 10 of which efficiency has become equal to or lower than a given threshold, as warning information. The warning information may indicate, for example, that the PSU 10 may fail in the near future or that there is a sign of a failure. The warning information may be referenced, for example, by an administrator of the server 1 using an IO device of the server 1 or using an administrator terminal (computer) connected via a communication IF of the server 1 and a network (including the Internet).

Moreover, swapping between operating PSUs 10 and standby PSUs 10 may be performed at a given timing. The given timing includes at least one timing selected from, for example, every given cycle, when it is determined to change the number N of operating units, and every cycle longer than the given cycle (e.g., every one day).

For example, the PSU determination unit 53 may swap the output state between one or more operating PSUs 10 and standby PSUs 10 of the same number as the number of the operating PSUs 10. As one example, when the number of PSUs 10 in the operating state is equal to or greater than the number of PSUs 10 in the standby state, the PSU determination unit 53 may switch all PSUs 10 in the standby state to the operating state and switch operating PSUs 10 in the same number as the number of PSUs 10 in the standby state, to the standby state. On the other hand, when the number of PSUs 10 in the operating state is less than the number of PSUs 10 in the standby state, the PSU determination unit 53 may switch standby PSUs 10 equal to the number of PSUs 10 in the operating state to the operating state, and then switch the same number of operating PSUs 10 to the standby state.

Since the operating time of each of the plurality of PSUs 10 can be equalized by performing such swapping of output states, the efficiencies of the PSUs 10 can also be equalized and the operational stability of the server 1 can be improved. In addition, since the failure rate of each of the plurality of PSUs 10 can also be reduced, the operational stability of the server 1 can be further improved also from the viewpoint of reducing the failure rate.

Note that the method for determining the operating PSUs 10 is not limited to the method described above. For example, the PSU determination unit 53 may change the output state only for the number of units corresponding to the difference between the number of units to be the operating PSUs 10 and the number of PSUs 10 currently in the operating state, while maintaining the current output state for the other PSUs 10.

### (A-2-2) Another Example of Method for Determining Number of Operating Units

There is a correlation between the value of the input voltage of the PSU 10 (DC-DC converter 12), or the internal temperature (component temperature) of the PSU 10 (DC-DC converter 12), and the efficiency curve. For example, as described above, the efficiency of the PSU 10 changes with the load current, but due to the influence of one or both of the input voltage and the internal temperature, the efficiency curve fluctuates, and the timing suitable for switching the number of operating units (switching points: β2, β3, β4) thus varies.

For example, the current value of the switching point when the input voltage value is relatively low may be smaller than the current value of the switching point when the input voltage value is relatively high. In contrast, for example, the current value of the switching point when the component temperature is relatively low may be smaller than the current value of the switching point when the component temperature is relatively high.

Therefore, for example, the relationship between the efficiency and the load current may be measured and calculated in advance for either or both of each segment of input voltage values and each segment of component temperatures, and stored in the efficiency table 51a. In this case, the PSU determination unit 53 may also update the efficiency table 51a based on the information obtained from each PSU 10 at timings such as every given cycle or every cycle longer than the given cycle. The efficiency table 51a may store, for example, at least the switching points of the number N of operating units and the relationship between the number N of operating units and the load current range corresponding to the load current ranges, for each segment of input voltage values, for each segment of component temperatures, or for each segment of input voltage values and each segment of component temperatures.

The PSU determination unit 53 may determine the number N of operating units by referring to the efficiency table 51a based on the load current, the input voltage, and the component temperature obtained by the information obtainment unit 52, for example. For example, the number N of operating units may be determined, among the entries that correspond to both the segment to which the input voltage belongs and the segment to which the component temperature belongs, based on the relationship between the load current and each switching point.

Alternatively, in the efficiency table 51a, the relationship between the efficiency and the load current corresponding to a reference value of the input voltage and a reference value of the component temperature may be set. In this case, the PSU determination unit 53 may modify (calculate) each switching point according to the amount of change or rate of change of the input voltage or the component temperature from the reference value.

As described above, in the efficiency control, the power conversion efficiency can be further improved, by further taking into account one or both of the input voltage and the component temperature.

### (B) Example of Operation of Server According to One Embodiment

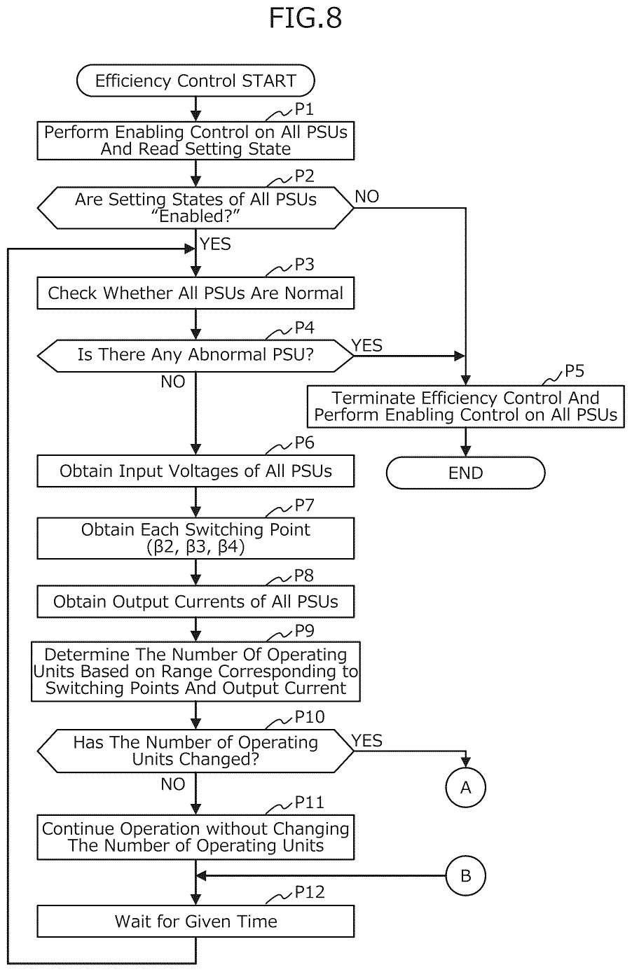

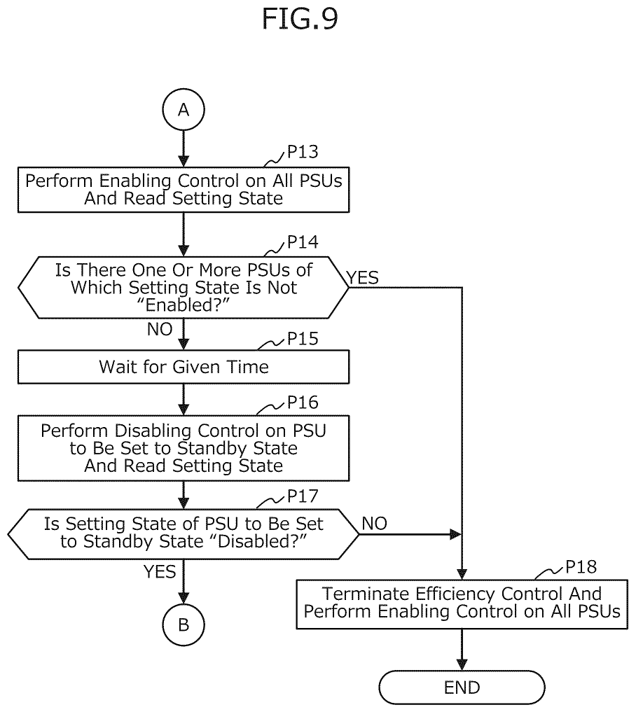

Next, an example of the operation of the server 1 according to one embodiment will be described. FIG. 8 and FIG. 9 are flowcharts for explaining an example of the operation of the server 1 according to one embodiment. In FIGS. 8 and 9, for example, an example of the operation of the efficiency control by the control unit 5 and the plurality of PSUs 10 is described.

In FIG. 8, for example, it is assumed that the efficiency control is started when an external power source has been connected to the PSUs 10 of the server 1, each PSU 10 has been turned on and supply of power has been started, the processing device 4 has started up, and the firmware of the control unit 5 has been started.

In Step P1, the control unit 5 performs the enabling control on all PSUs 10 and reads the setting state of the enabling control or the disabling control in each PSU 10. For example, the signal transmission unit 54 transmits operation control signals S1a and S1b indicating an operation instruction to all PSUs 10, thereby causing each PSU 10 to perform the enabling control such as the droop function. The information obtainment unit 52 then obtains the current enabled or disabled state of the droop function or the like from each PSU 10. This is performed to confirm whether the instruction by the software match the setting state of hardware in each PSU 10. The same applies in the following description.

In Step P2, the control unit 5 determines whether or not the setting states of all PSUs 10 are “enabled.” If the setting state of one or more PSUs 10 is not “enabled” (NO in Step P2), the process proceeds to Step P5. If the setting state of all PSUs 10 is “enabled” (YES in Step P2), the process proceeds to Step P3.

In Step P3, the control unit 5 checks whether or not all PSUs 10 are normal. In Step P4, the control unit 5 determines whether or not there is any abnormal (for example, failed) PSU 10. If there is an abnormal PSU 10 (YES in Step P4), the process proceeds to Step P5. If there is no abnormal PSU 10 (NO in Step P4), the process proceeds to Step P6.

In Step P5, the control unit 5 terminates the efficiency control and performs the enabling control on all PSUs 10, and the process ends. In this case, the control unit 5 may record abnormality information indicating the occurrence of an abnormality in the memory unit 51 and may notify the administrator or the like of the occurrence of the abnormality.

In Step P6, the information obtainment unit 52 obtains the input voltages of all PSUs 10. In Step P7, the PSU determination unit 53 obtains (selects or calculates) each switching point (e.g., β2, β3, and β4) corresponding to the information obtained in Step P6. Note that the process in Step P6 may be omitted, and the component temperature of the power conversion circuit 18 of all PSUs 10 may be obtained instead of or in addition to obtaining the input voltage in Step P6.

In Step P8, the information obtainment unit 52 obtains the values of the output currents Iout of all PSUs 10. In Step P9, the PSU determination unit 53 determines the number N of operating units based on the range corresponding to the switching points and the output current Iout (for example, the load current which is the sum of the output currents Iout).

In Step P10, the PSU determination unit 53 determines whether or not there is a change (difference) between the number N of operating units and the number of units currently operating. If there is no change (NO in Step P10), the process proceeds to Step P11. If there is a change (YES in Step P10), the process proceeds to Step P13 in FIG. 9.

In Step P11, the control unit 5 continues operation without changing the number of units currently operating. At this time, the PSU determination unit 53 may switch the operating PSUs 10 and the standby PSUs 10 according to the method described above. In Step P12, the control unit 5 waits for a given period and then the process proceeds to Step P3.

In Step P13, the control unit 5 performs the enabling control on all PSUs 10 and reads the setting state of the enabling control or the disabling control in each PSU 10.

In Step P14, the control unit 5 determines whether or not there is one or more PSUs 10 of which setting state is not “enabled.” If there is one or more PSUs 10 of which setting state is not “enabled” (YES in Step P14), the process proceeds to Step P18. If there is no PSU 10 of which setting state is not “enabled” (NO in Step P14), the process proceeds to Step P15.

In Step P15, the control unit 5 waits for a given time, for example 1 millisecond (ms). At this time, the PSU determination unit 53 may determine a PSU 10 to be set to the operating state and a PSU 10 to be set to the standby state.

In Step P16, the control unit 5 performs the disabling control on the PSU 10 to be set to the standby state and reads the setting state of the enabling control or the disabling control in the PSU 10. For example, the signal transmission unit 54 transmits the operation control signals S1a and S1b indicating a standby instruction to the PSU 10, thereby causing the PSU 10 to perform the disabling control such as the droop function. The information obtainment unit 52 then obtains the current enabled or disabled state of the droop function or the like from the PSU 10.

In Step P17, the control unit 5 determines whether or not the setting state of the PSU 10 to be set to the standby state is “disabled.” If the setting state is “disabled” (YES in Step P17), since the disabling control has been successfully completed, the process proceeds to Step P12 of FIG. 8.

If the setting state is not “disabled” (NO in Step P17), the disabling control has not been successfully completed. In this case, the process proceeds to Step P18.

In Step P18, the control unit 5 terminates the efficiency control and performs the enabling control on all PSUs 10, and the process ends, similarly to Step P5. In this case, the control unit 5 may record abnormality information indicating the occurrence of an abnormality in the memory unit 51 and may notify the administrator or the like of the occurrence of the abnormality.

Note that in Step P13, since all PSUs 10 are once subjected to the enabling control, the change in the number of units in Steps P16 and P17 is a control to decrease the number of operating units, except in a case where all units are set to be operating PSUs 10. However, after the disabling control has been successfully completed, the number of operating PSUs 10 increases or decreases from the number of PSUs 10 in the operating state at the time of Step P9, and matches the number N of operating units determined in Step P9. That is, in the process from Step P9, via the YES route in Step P10, and via the YES route in Step P17, a control for increasing or decreasing the number of operating PSUs 10 is performed. Note that in a case where all units are set to be operating PSUs 10, the processes in Steps P16 and P17 may be omitted (skipped).

### (C) Others

The technique according to the above-described embodiment can be modified or varied as follows.

For example, the hardware configuration of the PSU 10 illustrated in FIG. 2 may be combined in any combination, or may be divided individually. In addition, the functional configurations of the control unit 5 illustrated in FIG. 6 may be combined in any combination, or may be divided individually.

Furthermore, the efficiency table 51a stored in the control unit 5 may be stored in the controller 17 in at least one of the plurality of PSUs 10. In this case, instead of the control unit 5, one PSU 10 of the plurality of PSUs 10 may operate as a master, and the master controller 17 may embody the functions of the control unit 5. In order for the master controller 17 to control the plurality of PSUs 10, for example, each of the plurality of PSUs 10 may be connected via a dedicated control line, or the signal line L1 may be used.

Furthermore, although it has been assumed that the PSUs 10 other than the operating PSUs 10 are all in the standby state in one embodiment, at least one of them may be completely stopped. In the stabilization control, it is sufficient for one or more PSUs 10 to be set to the standby state, and the power loss is reduced when a PSU 10 is completely stopped than when it is in the standby state. Therefore, by controlling the plurality of PSUs 10 other than the operating PSUs 10 so that they are either in the standby state or in the completely stopped state, it is possible to respond to instantaneous load fluctuations while enhancing the loss reduction effect.

In addition, even in the standby state, a PSU 10 consumes power for operations of internal circuits and for cooling by a fan. Therefore, in the standby state, the controller 17 may reduce the oscillation frequency of the power conversion circuit 18. The oscillation frequency is one example of an operating frequency. As a result, the higher the power consumption of a PSU 10 in the standby state, the greater the reduction in power consumption in the standby that can be achieved, thereby improving the overall efficiency of the server 1. Note that, for a PSU 10 of which power consumption in the standby state is sufficiently small, the reduction of the oscillation frequency of the power conversion circuit 18 may be omitted.

Furthermore, although the PSU 10 includes a signal indicating the internal temperature of the DC-DC converter 12 in the signals S1a and S1b, the PSU 10 may additionally or alternatively include a signal indicating the external temperature of the PSU 10 (for example, the housing temperature or ambient temperature of the DC-DC converter 12, or the housing temperature or ambient temperature of the PSU 10). In this case, the relationship between the efficiency and the load current may additionally be measured and calculated in advance for each segment of the external temperature, and may be stored in the efficiency table 51a. Also, for example, in the efficiency table 51a, the PSU determination unit 53 may determine the number N of operating units based on the relationship between the load current and each switching point from among entries matching one or both of the segment to which the input voltage belongs, and the segment to which the component temperature or the segment to which the external temperature belongs. Alternatively, the efficiency table 51a may store the relationship between the efficiency and the load current corresponding to a reference value of the input voltage and a reference value of the component temperature or a reference value of the temperature. In this case, the PSU determination unit 53 may correct (calculate) each switching point according to the change amount or change ratio from the reference value of the input voltage, component temperature, or external temperature.

In one aspect, the present disclosure can improve stability when a plurality of power supply units are operated according to the load.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus comprising:
a plurality of power supply units configured to supply power to a load via an output line,
wherein each of the plurality of power supply units comprises:
output circuitry configured to, when in a power supplying state for supplying the power, output to the output line an output current, and output to the output line an output voltage having a characteristic in which a voltage value decreases from a first voltage value in accordance with an increase in the output current, and, when in a stopped state for stopping the supply of the power, output to the output line the output voltage maintained at a second voltage value that is lower than the first voltage value; and
a controller configured to perform a control to set the output circuitry to the power supplying state, when the output circuitry is in the stopped state and when a voltage value on the output line becomes equal to or lower than the second voltage value of the output voltage from the output circuitry.

2. The information processing apparatus according to claim 1,
wherein the characteristic set in the output circuitry is set such that, when a current value of the output current output from the output circuitry in the power supplying state reaches a current threshold at which a number of operating power supply units providing a higher power conversion efficiency is switched from one to two, the output voltage output from the output circuitry in the power supplying state becomes equal to the second voltage value.

3. The information processing apparatus according to claim 1, further comprising
a control device configured to output, to each of the plurality of controllers, a signal for controlling the output circuitry to either the power supplying state or the stopped state, based on a current value of the output current output from the output circuitry in the power supplying state and one or more thresholds for switching the number of operating power supply units.

4. The information processing apparatus according to claim 3,
wherein the one or more thresholds are one or more current values of the output current output from the one or more output circuitry in the power supplying state when the number of operating power supply units providing the higher power conversion efficiency is switched.

5. The information processing apparatus according to claim 3,
wherein the control device is configured to determine the number of operating power supply units to be set to the power supplying state, based on one or both of an input voltage input to the output circuitry in the power supplying state and an internal temperature of the output circuitry or an external temperature of the power supply units in the power supplying state, the one or more thresholds, and a current value of the output current output from the output circuitry in the power supplying state.

6. The information processing apparatus according to claim 1,
wherein each of the plurality of controllers is configured to reduce an operating frequency of the output circuitry, when the output circuitry is in the stopped state for outputting the output voltage at the second voltage value.

7. A power supply control method comprising:
in each of a plurality of power supply units configured to supply power to a load via an output line,
when in a power supplying state for supplying the power,
outputting, by output circuitry, to the output line an output current, and outputting to the output line an output voltage having a characteristic in which a voltage value decreases from a first voltage value in accordance with an increase in the output current;
when in a stopped state for stopping the supply of the power,
outputting by the output circuitry to the output line the output voltage maintained at a second voltage value that is lower than the first voltage value; and
performing by a controller a control to set the output circuitry to the power supplying state, when a voltage value on the output line becomes equal to or lower than the second voltage value of the output voltage from the output circuitry.

8. The power supply control method according to claim 7,
wherein the characteristic set in the output circuitry is set such that, when a current value of the output current output from the output circuitry in the power supplying state reaches a current threshold at which a number of operating power supply units providing a higher power conversion efficiency is switched from one to two, the output voltage output from the output circuitry in the power supplying state becomes equal to the second voltage value.

9. The power supply control method according to claim 7, comprising,
by a control device,
outputting, to each of the plurality of controllers, a signal for controlling the output circuitry to either the power supplying state or the stopped state, based on a current value of the output current output from the output circuitry in the power supplying state and one or more thresholds for switching the number of operating power supply units.

10. The power supply control method according to claim 9,
wherein the one or more thresholds are one or more current values of the output current output from the one or more output circuitry in the power supplying state when the number of operating power supply units providing the higher power conversion efficiency is switched.

11. The power supply control method according to claim 9, comprising,
by the control device, determining the number of operating power supply units to be set to the power supplying state, based on one or both of an input voltage input to the output circuitry in the power supplying state and an internal temperature of the output circuitry or an external temperature of the power supply units in the power supplying state, the one or more thresholds, and a current value of the output current output from the output circuitry in the power supplying state.

12. The power supply control method according to claim 7, comprising,
by each of the plurality of controllers, reducing an operating frequency of the output circuitry, when the output circuitry is in the stopped state for outputting the output voltage at the second voltage value.
